(19) United States
(12) Patent Application Publication
(10) Pub. No.: US 2020/0125140 A1
(43) Pub. Date: Apr. 23, 2020

(54) ACCESSIBILITY OF COMPONENTS

(71) Applicant: HEWLETT-PACKARD DEVELOPMENT COMPANY, L.P., Spring, TX (US)

(72) Inventors: Peter Siyuan Zhang, Houston, TX (US); Srinath Balaraman, Houston, TX (US)

(21) Appl. No.: 16/481,139

(22) PCT Filed: Jul. 13, 2017
(86) PCT No.: PCT/US2017/041911

§ 371 Date: Jul. 26, 2019

(51) Int. Cl. G06F 1/16; G06F 1/3206; G06F 1/3287

(52) U.S. Cl. CPC G06F 1/1618; G06F 1/3287; G06F 1/3206; G06F 1/1677

(57) ABSTRACT

Example implementations relate to accessibility of components. In an example, the system may include a processing resource and a memory resource storing readable instructions to cause the processing resource to determine, in response to a sensor value, a state of a computing device that includes a plurality of components, determine, in response to the state of the computing device, an accessibility of the plurality of components, select a component from the plurality of components based on the accessibility of the plurality of components, and alter an electrical state of the selected component that is utilized to identify a user.

### BACKGROUND

An electronic device may receive a user input via different devices. The different devices may include a computer keyboard, a computer mouse, a camera, a fingerprint receptor, and/or a microphone.

### BRIEF DESCRIPTION OF THE DRAWINGS

FIG. 1 illustrates an example computing device to determine an accessibility of a component in accordance with the disclosure.

FIG. 2 illustrates an example of a system to determine an accessibility of a component in accordance with the disclosure.

FIG. 3 illustrates a block diagram of an example method for determining an accessibility of a component in accordance with the disclosure.

FIG. 4 illustrates a block diagram of an example method for determining an accessibility of a component in accordance with the disclosure

### DETAILED DESCRIPTION

A computing device may include a processing resource such as electronic circuitry to execute instructions stored on machine-readable medium to perform various operations. Computing devices may be static or mobile. A static computing device may include a computing device designed for regular use in a single location. For example, a static computing device may include a desktop computer or other computing device that is utilized in a single location. A mobile computing device may include a portable computing device that is designed to be used in a variety of settings and to be transported between them with relatively little effort. A mobile computing device may combine inputs, outputs, components, and capabilities that are otherwise separate in a static computing device. A mobile computing device may include a laptop computer, smartphone, other smart device, a tablet computer, a personal digital assistant, a convertible laptop, etc.

A computing device may include a component to receive a user input. For example, the component may include a mouse, a keyboard, a fingerprint receptor, a camera, a microphone, and/or a touchscreen. One of the components may be more or less accessible than other components based on a state of the computing device. In some previous examples, an accessibility of a component compared to other components can be unknown to the computing device. For example, a laptop computing device that is closed, but coupled to an external monitor may still be operating as if the laptop were open. In this example, a component of the laptop computing device, such as a built-in keyboard and/or a fingerprint receptor, may also be operating as if it were ready to receive a user-input. However, in this example, these components that are covered when the laptop computing device is closed are less likely to be accessible to a user.

Example implementations relate to determining an accessibility of components. In an example, the system may include a processing resource and a memory resource storing machine-readable instructions to cause the processing resource to determine, in response to a sensor value, a state of a computing device that includes a plurality of components, determine, in response to the state of the computing device, an accessibility of the plurality of components, select a component from the plurality of components based on the accessibility of the plurality of components, and alter an electrical state of the selected component that is utilized to identify a user. In this way, the example implementations can be utilized to determine an accessibility of particular components and alter an electrical state of the components based on the accessibility.

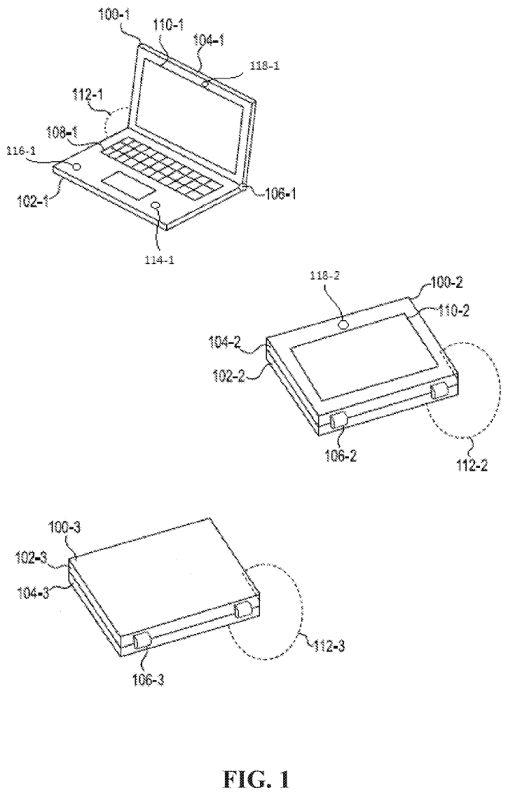

FIG. 1 illustrates an example of a computing device 100-1, 100-2, 100-3 in a plurality of different physical states in accordance with the disclosure. In some examples, the computing device 100-1, 100-2, 100-3 may be a mobile computing device. In some examples, the computing device 100-1, 100-2, 100-3 may be a convertible computing device. As used herein, a convertible computing device may include a computing device that is convertible for use as a traditional laptop computing device accepting input from an integrated physical keyboard and/or a touchscreen or as a tablet computing device accepting input from just the touchscreen. The convertible laptop may utilize distinct Basic Input/Output System (BIOS) modes that control the allowable or recognized inputs and/or outputs associated with the traditional laptop and/or tablet computing device.

The computing device 100-1, 100-2, 100-3 may include a plurality of connected housings (e.g., 102-1, 102-2, 102-3, 104-1, 104-2, 104-3). For example, the computing device 100-1, 100-2, 100-3 may include a first housing 102-1, 102-2, 102-3. The first housing 102-1, 102-2, 102-3 may include a housing containing the computing portion of the computing device 100-1, 100-2, 100-3. The computing portion may include the processing resource (e.g., a central processing unit (CPU), a graphics processing unit (GPU), etc.), a memory resource, an input/output port, and/or a battery. The computing portion may include the components that enable the operation of the operating system and applications of the computing device 100-1, 100-2, 100-3. The computing portion may include the hardware that executes commands and generates outputs for the computing device 100-1, 100-2, 100-3. The first housing 102-1, 102-2, 102-3 may include a plurality of components including, for example, a keyboard 108-1, a microphone 116-1, and/or a fingerprint receptor 114-1, as shown in FIG. 1.

The computing device 100-1, 100-2, 100-3 may include a second housing 104-1, 104-2, 104-3. The second housing 104-1, 104-2, 104-3 may include hardware associated with generating a displayed image of a user interface. The second housing 104-1, 104-2, 104-3 may also include hardware associated with a touchscreen user interface. The second housing 104-1, 104-2, 104-3 may include a plurality of components including, for example, a camera 118-1, 118-2 and/or an integrated display 110-1, 110-2.

The first housing 102-1, 102-2, 102-3 and the second housing 104-1, 104-2, 104-3 may be connected. The connection between the first housing 102-1, 102-2, 102-3 and the second housing 104-1, 104-2, 104-3 may be designed to be a substantially permanent connection that is not designed to be readily and/or repeatedly disconnected. For example, the connection may accommodate wiring between connection points in the first housing 102-1, 102-2, 102-3 and connection points in the second housing 104-1, 104-2, 104-3 that is not releasable from the connection points in either housing without damaging the computing device 100-1, 100-2, 100-3 (e.g., wiring soldered to circuitry at the connection points). However, examples are not so limited. For example, the second housing 104-1, 104-2, 104-3 may be detachable from the first housing 102-1, 102-2, 102-3 such that only the second housing 104-1, 104-2, 104-3 may be utilized by a user. In this example, the first housing 102-1, 102-2, 102-3 may be, for example, determined to be less accessible and/or inaccessible, and deactivated.

The connection between the first housing 102-1, 102-2, 102-3 and the second housing 104-1, 104-2, 104-3 may include a hinge mechanism 106-1, 106-2, 106-3. The first housing 102-1, 102-2, 102-3 and the second housing 104-1, 104-2, 104-3 may be rotatable about the hinge mechanism 106-1, 106-2, 106-3. Rotation of the first housing 102-1, 102-2, 102-3 and the second housing 104-1, 104-2, 104-3 about a rotational axis passing through a center the hinge mechanism 106-1, 106-2, 106-3 may alter an orientation of the first housing 102-1, 102-2, 102-3 and the second housing 104-1, 104-2, 104-3 with respect to each other by altering an angle between the first housing 102-1, 102-2, 102-3 and the second housing 104-1, 104-2, 104-3.

The determination of the configuration of the computing device 100-1, 100-2, 100-3 may be based on an orientation of the components of the computing device 100-1, 100-2, 100-3. The orientation of the components of the computing device 100-1, 100-2, 100-3 may include the positioning of the components in relation to each other and/or in relation to a user or a work surface. As used herein, a work surface may include a surface that the computing device 100-1, 100-2, 100-3 is sitting on and/or supported by during its operation. Examples of a work surface may include a desk, a user's lap, a palm of a hand, a wall, a piece of furniture, the ground, etc. Examples of an orientation may include a positional relationship between the first housing 102-1, 102-2, 102-3 and the second housing 104-1, 104-2, 104-3, a positional relationship between the integrated display 110-1, 110-2 and the integrated physical keyboard 108-1, a positional relationship between a functional side of the integrated display 110-1, 110-2 and a functional side of the integrated physical keyboard 108-1, and/or a positional relationship of any one of the plurality of components (e.g., located on the first housing 102-1, 102-2, 102-3) and a user and/or a work surface. In some examples, the determination of the orientation of the computing device 100-1, 100-2, 100-3 can be obtained by the angle measured by sensors of the computing device 100-1, 100-2, 100-3.

A positional relationship between the components of the computing device 100-1, 100-2, 100-3 may be quantified using an angle 112-1, 112-2, 112-3 (illustrated by a hashed line) between the components. The angles 112-1, 112-2, 112-3 may be defined relative to a vertex. The vertex may include the hinge mechanism 106-1, 106-2, 106-3.

A positional relationship between the components of the computing device 100-1, 100-2, 100-3 and a user and/or a work surface may be characterized by which way the component faces relative to the user and/or the work surface. For example, a positional relationship between a user and the functional side of the integrated display 110-1, 110-2 may be characterized by whether the functional side of the integrated display 110-1, 110-2 is facing a face of a user. In another example, a positional relationship between a work surface and an integrated physical keyboard 108-1 may be characterized by whether the functional side of the integrated physical keyboard 108-1 is facing the work surface.

In some examples, a first set of a plurality of sensors may be implemented in the first housing 102-1, 102-2, 102-3, and a second set of the plurality of sensors may be implemented in the second housing 104-1, 104-2, 104-3. As such, for example, a usage mode can be determined from a plurality of modes based on the measured angle between the first set and the second set of the plurality of sensors. In some examples, the usage mode can be determined from a plurality of modes based on the angle between the first set of the plurality of sensors and gravity. For example, the plurality of modes includes a laptop mode, a tablet mode, a tent mode, a flat mode, and a stand mode, among other usage modes. The plurality of modes may be utilized to determine the state of the computing device 100-1, 100-2, 100-3.

For example, based on the measured angle (e.g., angle 112-1, 112-2, 112-3) between a first accelerometer sensor (e.g., located on the first housing 102-1, 102-2, 102-3) and a second accelerometer sensor (e.g., located on the second housing 104-1, 104-2, 104-3), an embedded controller (EC) can determine which usage mode the computing device 100-1, 100-2, 100-3 is operating in. As described herein, each usage mode may be known and correspond to a predefined open angle range. For example, the laptop mode can correspond to a display open angle of less than 155 degrees, the tablet mode can correspond to a display open angle of greater than 345 degrees, the tent mode can correspond to a display open angle of between 210 degrees and 335 degrees, the flat mode can correspond to a display open angle of between 165 degrees and 200 degrees, and the stand mode can correspond to a display open angle of between 210 degrees and 335 degrees. In some examples, the angle between the first set of sensors and/or the second set of sensors, and gravity may be used to differentiate different usage modes with the same open angle range.

In some examples, the computing device 100-1, 100-2, 100-3 may be in the laptop mode, as illustrated by the computing device 100-1. For example, an angle 112-1 between the first housing 102-1 and the second housing 104-1 may correspond to a display open angle of less than 155 degrees, although examples are not so limited. As shown by the computing device 100-1, a plurality of components (e.g., keyboard 108-1, camera 118, fingerprint receptor 114-1, integrated display 110, and/or microphone 116-1) may be determined to be accessible to a user. For example, the angle 112-1 may be wide enough to allow the user to easily access (e.g., enter inputs) each one of the plurality of components. As such, during the laptop mode, the plurality of components may be activated.

In some examples, some of the plurality of components may be determined to be less accessible and/or inaccessible when the computing device 104-1 is in the laptop mode. The angle 112-1 may be too small to allow a user, for example, to access some of the plurality of components while the computing device 104-1 may still recognize itself as being in the laptop mode. In this example as shown by the computing device 100-1, the state of the computing device 104-1 may be altered, based on a sensor value of the sensor (e.g., of the computing device), from a known mode of the laptop mode such that some of the plurality of components (e.g., the camera 118 and/or the integrated display 110 may be determined to be less accessible (e.g., than other components such as the keyboard 108-1, fingerprint receptor 114-1, and/or the microphone) and/or inaccessible. An electrical state of the components may be further altered (e.g., deactivation), accordingly.

In some examples, the computing device may be in the tablet mode, as illustrated by the computing device 100-2. For example, an angle 112-2 between the first housing 102-2 and the second housing 104-2 may correspond to a display open angle of greater than 345 degrees, although examples are not so limited. In this example shown by the computing device 100-2, a set of the plurality of components may be determined to be less accessible and/or inaccessible than another set of the plurality of components. For example, during the tablet mode, the keyboard 108-1, fingerprint receptor 114-1, and/or microphone 116-1 may be less accessible to a user than the integrated display 110-2 and/or camera 118-2 since the keyboard 108-1 and/or the fingerprint receptor 114-1, which are located on the functional side of the first housing 102-2 may not face the user. As such, the keyboard 108-1 and/or the fingerprint receptor 114-1 may be deactivated.

In some examples, the computing device may be in the non-usage mode, as illustrated by the computing device 100-3. For example, an angle 112-3 between the first housing 102-3 and the second housing 104-3 may correspond to a display open angle of less than 20 degrees, although examples are not so limited. In some examples (e.g., as shown by the computing device 100-3), the first housing 102-3 and the second housing 104-3 may be in contact with each other.

In this example, the plurality of components (e.g., keyboard 108-1, camera 118, fingerprint receptor 114-1, integrated display 110, and/or microphone 116-1) may be determined to be, for example, inaccessible, and an electrical state of those components may be altered (e.g., deactivation), accordingly. In some examples, the computing device 100-3 may still be operating when the computing device 100-3 is coupled to, for example, an external monitor. However, the plurality of components may still be inaccessible to a user due to the orientation as shown by the computing device 100-3. As such, the plurality of components may remain and/or be deactivated while the computing device 100-3 is operating.

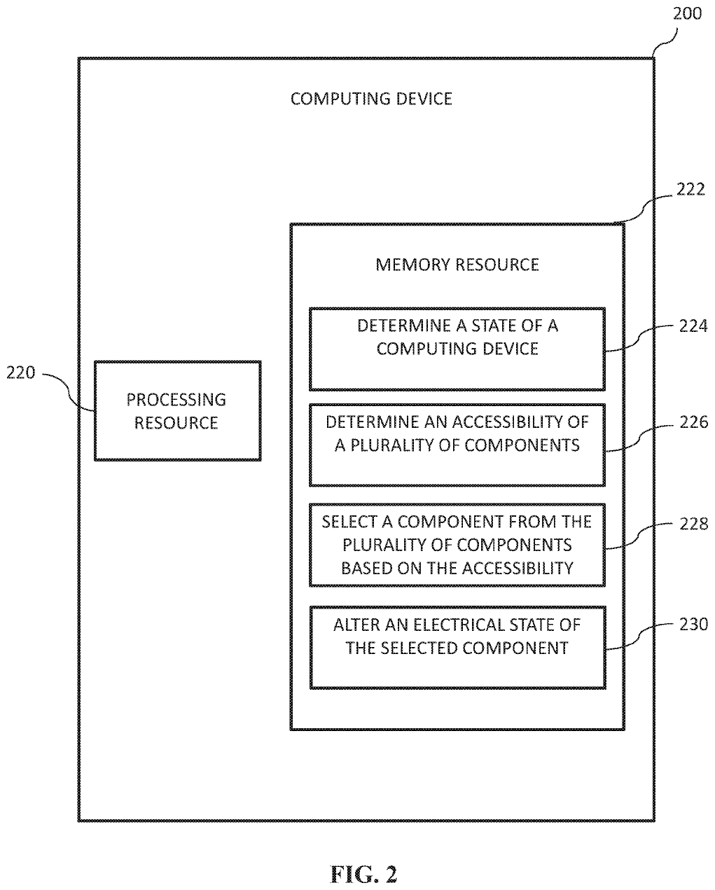

FIG. 2 illustrates an example computing device 200 to determine an accessibility of a component in accordance with the disclosure. The computing device 200 may be a convertible computing device. As used herein, a convertible computing device may include a computing device 200 that is convertible for use as a traditional laptop computing device accepting input from an integrated physical keyboard and/or a touchscreen or as a tablet computing device accepting input from just the touchscreen. The convertible laptop may utilize distinct Basic Input/Output System (BIOS) modes that control the allowable or recognized inputs and/or outputs associated with the traditional laptop and tablet computing device.

As illustrated in FIG. 2, the computing device 200 can include a processing resource 220. The computing device 200 may further include a memory resource 222 coupled to the processing resource 220, on which instructions may be stored, such as instructions 224, 226, 228, and 230. Although the following descriptions refer to a single processing resource and a single memory resource, the descriptions may also apply to a system with multiple processing resources and/or multiple memory resources. In such examples, the instructions may be distributed (e.g., stored) across multiple memory resources and the instructions may be distributed across (e.g., executed by) multiple processing resources.

Processing resource 220 may be a central processing unit (CPU), a semiconductor based microprocessor, and/or other hardware devices suitable for retrieval and execution of instructions stored in memory resource 222. Processing resource 220 may fetch or retrieve, decode, and execute instructions 224, 226, 228, and 230, or a combination thereof. As an alternative or in addition to retrieving and executing instructions, processing resource 220 may include at least one electronic circuit that includes electronic components for performing the functionality of instructions 224, 226, 228, and 230, or a combination thereof.

Memory resource 222 can be volatile or nonvolatile memory. Memory resource 222 can also be removable (e.g., portable) memory, or non-removable (e.g., internal) memory. For example, memory resource 104 can be random access memory (RAM) (e.g., dynamic random access memory (DRAM) and/or phase change random access memory (PCRAM)), read-only memory (ROM) (e.g., electrically erasable programmable read-only memory (EEPROM) and/or compact-disk read-only memory (CD-ROM), flash memory, a laser disc, a digital versatile disk (DVD) or other optical disk storage, and/or a magnetic medium such as magnetic cassettes, tapes, or disks, among other types of memory.

Instructions 224, when executed by processing resource 220, may cause the processing resource 220 to determine, in response to a sensor value, a state of a computing device that includes a plurality of components. A state of the computing device 200 may correspond to a particular Basic Input/Output System (BIOS) mode that the computing device 200 is operating or utilizing. The computing device 200 may function differently depending on which state the computing device 200 is utilizing. For example, a particular state may be associated with particular operations, inputs, and/or outputs being allowed or not-allowed. The determination of the state of the computing device 200 may be based on the orientation of the components of the computing device 200, as described herein.

In various examples, the computing device 200 may include a sensor. For example, the sensor may include cameras, light sensors, pressure sensor, accelerometers, gyroscope, and/or hall sensor that may be utilized by the computing device 200 to determine, for example, an orientation of the computing device 200. In some examples, the orientation of the components of the computing device 200 may be determined based on user input specifying an orientation. In some examples, the orientation of the components of the computing device 200 may also be determined based on an angle between a sensor and gravity.

Instructions 226, when executed by processing resource 220, may cause the processing resource 220 to determine, in response to the state of the computing device, an accessibility of the plurality of components. In some examples, the determination of the accessibility of the plurality of components may be based on whether one of the plurality of components is more accessible than another one of the plurality of components. In some examples, the determination of the accessibility of the plurality of components may be based on whether each one of the plurality of components is inaccessible or not.

Instructions 228, when executed by processing resource 220, may cause the processing resource 220 to select a component from the plurality of components based on the accessibility of the plurality of components. In some examples, the instructions 228 may further include instructions to alter the accessibility of the plurality of components based on changes in the sensor value.

In some examples, information of the determined accessibility may be stored in the memory resource 222. The determined state of the component may be stored in a location (e.g., memory resource 222) that is accessible to, for example, the computing device 200, software being run by the computing device 200, and/or other devices electrically coupled to the computing device 200. However, examples are not so limited. For example, the determined state may be stored in a different location (e.g., memory resource other than the memory resource 222) that is accessible by the computing device 200, other software, and/or devices to be utilized to, for example, alter an electrical state of the selected component.

Instructions 230, when executed by processing resource 220, may cause the processing resource 220 to alter an electrical state of the selected component that is utilized to identify a user. In some examples, the electrical state may be a power consumption state such that the instructions 230, when executed by processing resource 220, may cause the processing resource 220 to alter the power-consumption state of the selected component. For example, the selected component may be activated and/or deactivated based on the determined accessibility of the selected component, as described herein.

In various examples, the plurality of components may be utilized by the computing device 200 to, for example, identify a user. The plurality of components may include a keyboard, a camera, a microphone, and/or a fingerprint receptor, although examples are not so limited. In some examples, the plurality of components of the computing device 200 may be a built-in component that was added to the computing device 200 during, for example, a manufacturing process of the computing device 200. In some examples, the plurality of components are utilized to authorize a user to access the computing device 200. For example, the computing device 200 may authorize the user by identifying an input received via the keyboard (e.g., password), the fingerprint receptor (e.g., fingerprint), and/or the camera (e.g., visual information of the user).

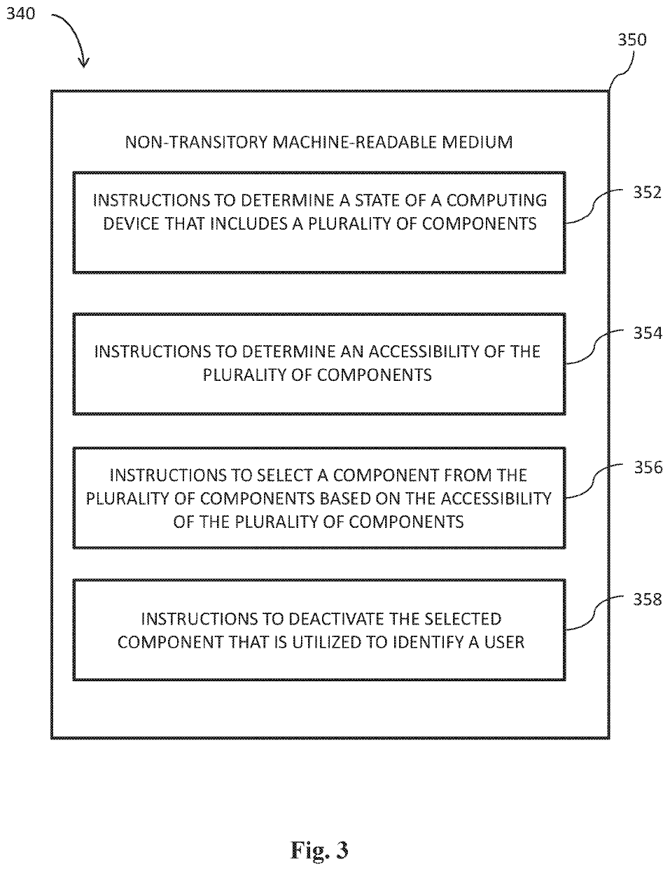

FIG. 3 illustrates an example of a system 340 to determine an accessibility of a component in accordance with the disclosure. The system 340 may include a non-transitory machine readable storage medium 350. Non-transitory machine readable storage medium 350 may be an electronic, magnetic, optical, or other physical storage device that stores executable instructions. Thus, non-transitory machine readable storage medium 350 may be, for example, Random Access Memory (RAM), an Electrically-Erasable Programmable Read-Only Memory (EEPROM), a storage drive, an optical disc, and the like. Non-transitory machine readable storage medium 350 may be disposed within the system 340, as shown in FIG. 3. In this example, the executable instructions may be “installed” on the system 340. Additionally and/or alternatively, non-transitory machine readable storage medium 350 may be a portable, external or remote storage medium, for example, that allows the system 340 to download the instructions from the portable/external/remote storage medium. In this situation, the executable instructions may be part of an “installation package”. As described herein, non-transitory machine readable storage medium 350 may be encoded with executable instructions for a performance threshold.

Instructions 352 may include instructions to determine a state of the computing device that includes a plurality of components. In some examples, instructions 352 to determine the state of the computing device may be based on a known mode of the computing device. A plurality of known modes may include a usage mode such as a laptop mode, a tablet mode, a tent mode, a flat mode, and a stand mode, and/or a sleep mode.

The mode of the computing device (e.g., a usage mode, as described herein) may be known when information of the mode is already determined prior to executing instructions stored in the medium 350. As such, the state of the component may be determined independently (e.g., without further determining based on a sensor value) from a sensor value of the computing device. Determining a state of the computing device based on a known mode of the computing device may provide benefits such as a fast and/or power-efficient execution of the instructions (e.g., a sensor value need not be monitored and/or computed), among other benefits.

In some examples, the state of the computing device can be an orientation of a one housing of the computing device relative to another housing of the computing device. The orientation may be determined based on an angle between a first housing and a second housing, as described herein. For example, the orientation can be determined based on an angle between a keyboard of a laptop computing device and a display of the laptop computing device.

Instructions 354 may include instructions to determine an accessibility of the plurality of components. In some examples, the instructions 354 to determine the accessibility of the plurality of components may be based on the state of the computing device. In some examples, the instructions 354 may further include instructions to deactivate the selected component in response to a determination that the selected component is inaccessible.

Instructions 356 may include instructions to select a component from the plurality of components based on the accessibility of the plurality of components. In some examples, the instructions 356 may include instructions to select a component that is less accessible than a different component of the plurality of components and/or inaccessible. Instructions 358 may include instructions to deactivate the selected component that is utilized to identify a user. In some examples, the instructions 358 may include instructions to deactivate the selected component while the computing device is in a usage mode.

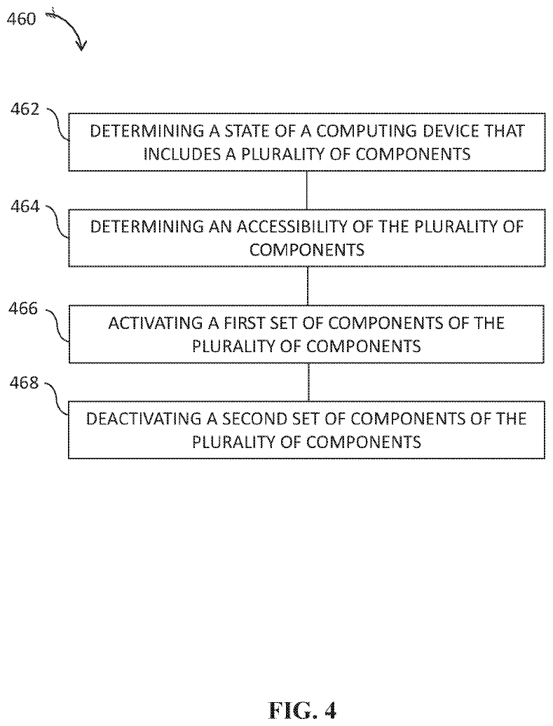

FIG. 4 illustrates a block diagram of an example method 460 for determining an accessibility of a component in accordance with the disclosure. In some examples, the method 460 can be performed by a computing device as described herein. For example, the method 460 can be performed by a processing resource (e.g.; processing resource 220) executing instructions stored on a non-transitory computer readable medium (e.g., memory resource 222).

At block 462, the method 460 may include determining a state of the computing device that includes a plurality of components. In some examples, determining the state of the computing device may be based on a known mode of the computing device and a sensor value of a sensor of the computing device. A plurality of known modes may include a usage mode such as a laptop mode, a tablet mode, a tent mode, a flat mode, and a stand mode, and/or a sleep mode.

At block 464, the method 460 may include determining an accessibility of the plurality of components. In some examples, determining the accessibility of the plurality of components may be based on the state (e.g., determined based on the known mode) of the computing device. Accessibility may be determined based on whether a component of the plurality of components is more or less accessible than a different component of the plurality of components and/or inaccessible.

In some examples, the method 460 may further include determining an accessibility based on an accessibility of a functional surface of a component of the plurality of components. As used herein, a functional side may include a surface on which a plurality of components are located. For example, the functional side of an integrated physical keyboard may include the surface of the integrated physical keyboard that is keyed with mechanically actuatable keys that correspond to particular alphanumeric and specific command inputs. As used herein, a functional surface or functional side of an integrated display may include a surface of the integrated display upon and/or through which an electronic visual display can be viewed. That is, the functional side of the integrated display may include a displaying surface of the integrated display. In some examples, the functional side of the integrated display may include a surface of the integrated display including a touchscreen input receiving device laid over the electronic visual display.

At block 466, the method 460 may include activating a first set of components of the plurality of components. At block 468, the method 460 may include deactivating a second set of components of the plurality of components. In some examples, the second set of components of the plurality of components may be determined to be less accessible than the first set of components. For example, when the computing device is in a tablet mode, components not located on a housing that includes an integrated display may be determined to be less accessible than those components located on the housing. In some examples, the first set of components may face the user while the second set of components does not face the user.

In some examples, the method 460 may include altering, based on the sensor value, the state of the computing device that is determined based on the known mode. For example, while the computing device may recognize itself as being in a usage mode, the sensor value may indicate that a component located on one of housings of the computing device may be less accessible (e.g., inaccessible) to a user than a different component that is located on another one of the housings. In this example, the state of the computing device may be altered to a different state such that an electrical state of those components determined to be less accessible may be altered consistent with the altered state.

In the foregoing detailed description of the present disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be utilized and that process, electrical, and/or structural changes may be made without departing from the scope of the present disclosure.

The figures herein follow a numbering convention in which the first digit corresponds to the drawing figure number and the remaining digits identify an element or component in the drawing. Elements shown in the various figures herein can be added, exchanged, and/or eliminated so as to provide a number of additional examples of the present disclosure. In addition, the proportion and the relative scale of the elements provided in the figures are intended to illustrate the examples of the present disclosure, and should not be taken in a limiting sense. As used herein, the designator “N”, particularly with respect to reference numerals in the drawings, indicates that a number of the particular feature so designated can be included with examples of the present disclosure. The designators can represent the same or different numbers of the particular features. Further, as used herein, “a number of” an element and/or feature can refer to one or more of such elements and/or features.

What is claimed:

1. A system, comprising:
a processing resource; and
a memory resource storing readable instructions to cause the processing resource to:
determine, in response to a sensor value, a state of a computing device that includes a plurality of components;
determine, in response to the state of the computing device, an accessibility of the plurality of components;
select a component from the plurality of components based on the accessibility of the plurality of components; and
alter an electrical state of the selected component that is utilized to identify a user.

2. The system of claim 1, further comprising instructions to cause the processing resource to determine the accessibility of the plurality of components based on whether one of the plurality of components is more accessible than another one of the plurality of components.

3. The system of claim 1, further comprising instructions to alter the accessibility of the plurality of components based on changes in the sensor value.

4. The system of claim 1, further comprising instructions to store information of the accessibility of the plurality of components in the memory resource.

5. The system of claim 1, wherein the plurality of components are utilized to authorize the user to access to the computing device.

6. The system of claim 1, wherein to alter the electrical state of the selected component comprises to alter a power-consumption state of the selected component.

7. A non-transitory machine readable medium comprising instructions executable by a processing resource to:
determine, in response to a known mode of a computing device, a state of the computing device that includes a plurality of components;
determine, in response to the state of the computing device, an accessibility of the plurality of components;
select a component from the plurality of components based on the accessibility of the plurality of components; and
deactivate the selected component that is utilized to identify a user.

8. The medium of claim 7, further comprising instructions to determine the state of the computing device independently from a sensor value of the computing device.

9. The medium of claim 7, further comprising instructions to deactivate the selected component while the computing device is in a usage mode.

10. The medium of claim 7, wherein the state of the computing device is an orientation of a first housing of the computing device relative to a second housing of the computing device.

11. The medium of claim 7, further comprising instructions to deactivate the selected component in response to a determination that the selected component is inaccessible.

12. A method, comprising:
determining, in response to a known mode of a computing device and a sensor value of a sensor of the computing device, a state of the computing device that includes a plurality of components;
determining, in response to the state of the computing device, an accessibility of the plurality of components that are utilized to identify a user;
activating a first set of components of the plurality of components; and
deactivating a second set of components of the plurality of components, wherein the second set of components are determined to be less accessible than the first set of components.

13. The method of claim 12, wherein, during the determined state of the computing device, the first set of components faces the user while the second set of components does not face the user.

14. The method of claim 12, further comprising altering, based on the sensor value, the state of the computing device that is determined based on the known mode of the computing device.

15. The method of claim 12, further comprising determining the accessibility of a component of the plurality of components based on an accessibility of a functional side of the component to the user.
